(19) United States
(12) Patent Application Publication
(10) Pub. No.: US 2024/0259554 A1
(43) Pub. Date: Aug. 1, 2024

(54) CANDIDATE DERIVATION FOR AFFINE MERGE MODE IN VIDEO CODING

(71) Applicant: BEIJING DAJIA INTERNET INFORMATION TECHNOLOGY CO., LTD., Beijing (CN)

(72) Inventors: Wei CHEN, San Diego, CA (US); Xiaoyu XIU, San Diego, CA (US); Yi-Wen CHEN, San Diego, CA (US); Hong-Jheng JHU, San Diego, CA (US); Che-Wei KUO, San Diego, CA (US); Ning YAN, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 18/611,410

(22) Filed: Mar. 20, 2024

Related U.S. Application Data
(63) Continuation of application No. PCT/US2022/044297, filed on Sep. 21, 2022.
(60) Provisional application No. 63/248,401, filed on Sep. 24, 2021.

(51) Int. Cl. H04N 19/105; H04N 19/129; H04N 19/176

(52) U.S. Cl. CPC H04N 19/105; H04N 19/129; H04N 19/176

(57) ABSTRACT

A method of video coding, an apparatus and a non-transitory computer-readable storage medium thereof are provided. The method includes obtaining one or more affine candidates from a plurality of non-adjacent neighbor blocks that are non-adjacent to a current block. The method may further include obtaining one or more control point motion vectors (CPMVs) for the current block based on the one or more affine candidates.

### CROSS-REFERENCE TO RELATED APPLICATIONS

The present application is a continuation application of International Application No. PCT/US2022/044297, filed Sep. 21, 2022, which claims priority to U.S. Provisional Application No. 63/248,401, entitled “Candidate Derivation for Affine Merge Mode in Video Coding,” filed on Sep. 24, 2021, all of which are incorporated by reference for all purposes.

### FIELD

The present disclosure relates to video coding and compression, and in particular but not limited to, methods and apparatus on improving the affine merge candidate derivation for affine motion prediction mode in a video encoding or decoding process.

### BACKGROUND

Various video coding techniques may be used to compress video data. Video coding is performed according to one or more video coding standards. For example, nowadays, some well-known video coding standards include Versatile Video Coding (VVC), High Efficiency Video Coding (HEVC, also known as H.265 or MPEG-H Part2) and Advanced Video Coding (AVC, also known as H.264 or MPEG-4 Part 10), which are jointly developed by ISO/IEC MPEG and ITU-T VECG. AOMedia Video 1 (AV1) was developed by Alliance for Open Media (AOM) as a successor to its preceding standard VP9. Audio Video Coding (AVS), which refers to digital audio and digital video compression standard, is another video compression standard series developed by the Audio and Video Coding Standard Workgroup of China. Most of the existing video coding standards are built upon the famous hybrid video coding framework i.e., using block-based prediction methods (e.g., inter-prediction, intra-prediction) to reduce redundancy present in video images or sequences and using transform coding to compact the energy of the prediction errors. An important goal of video coding techniques is to compress video data into a form that uses a lower bit rate while avoiding or minimizing degradations to video quality.

The first generation AVS standard includes Chinese national standard “Information Technology, Advanced Audio Video Coding, Part 2: Video” (known as AVS1) and “Information Technology, Advanced Audio Video Coding Part 16: Radio Television Video” (known as AVS+). It can offer around 50% bit-rate saving at the same perceptual quality compared to MPEG-2 standard. The AVS1 standard video part was promulgated as the Chinese national standard in February 2006. The second generation AVS standard includes the series of Chinese national standard “Information Technology, Efficient Multimedia Coding” (knows as AVS2), which is mainly targeted at the transmission of extra HD TV programs. The coding efficiency of the AVS2 is double of that of the AVS+. In May 2016, the AVS2 was issued as the Chinese national standard. Meanwhile, the AVS2 standard video part was submitted by Institute of Electrical and Electronics Engineers (IEEE) as one international standard for applications. The AVS3 standard is one new generation video coding standard for UHD video application aiming at surpassing the coding efficiency of the latest international standard HEVC. In March 2019, at the 68-th AVS meeting, the AVS3-P2 baseline was finished, which provides approximately 30% bit-rate savings over the HEVC standard. Currently, there is one reference software, called high performance model (HPM), is maintained by the AVS group to demonstrate a reference implementation of the AVS3 standard.

### SUMMARY

The present disclosure provides examples of techniques relating to improving the affine merge candidate derivation for affine motion prediction mode in a video encoding or decoding process.

According to a first aspect of the present disclosure, there is provided a method of video coding. The method may include obtaining one or more affine candidates from a plurality of non-adjacent neighbor blocks that are non-adjacent to a current block. Further, the method may include obtaining one or more control point motion vectors (CPMVs) for the current block based on the one or more affine candidates.

According to a second aspect of the present disclosure, there is provided a method for pruning an affine candidate. The method may include calculating a first set of affine model parameters associated with one or more CPMVs of a first affine candidate. Furthermore, the method may include calculating a second set of affine model parameters associated with one or more CPMVs of a second affine candidate. Moreover, the method may include performing a similarity check between the first affine candidate and the second affine candidate based on the first set of affine model parameters and the second set of affine model parameters.

According to a third aspect of the present disclosure, there is provided an apparatus for video coding. The apparatus includes one or more processors and a memory configured to store instructions executable by the one or more processors. Further, the one or more processors, upon execution of the instructions, are configured to perform the method according to the first aspect or the second aspect.

According to a fourth aspect of the present disclosure, there is provided a non-transitory computer-readable storage medium storing computer-executable instructions that, when executed by one or more computer processors, causing the one or more computer processors to perform the method according to the first aspect or the second aspect.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1 is a block diagram of an encoder in accordance with some examples of the present disclosure.

FIG. 2 is a block diagram of a decoder in accordance with some examples of the present disclosure.

FIG. 3A is a diagram illustrating block partitions in a multi-type tree structure in accordance with some examples of the present disclosure.

FIG. 3B is a diagram illustrating block partitions in a multi-type tree structure in accordance with some examples of the present disclosure.

FIG. 3C is a diagram illustrating block partitions in a multi-type tree structure in accordance with some examples of the present disclosure.

FIG. 3D is a diagram illustrating block partitions in a multi-type tree structure in accordance with some examples of the present disclosure.

FIG. 3E is a diagram illustrating block partitions in a multi-type tree structure in accordance with some examples of the present disclosure.

FIG. 4A illustrates 4-parameter affine model in accordance with some examples of the present disclosure.

FIG. 4B illustrates 4-parameter affine model in accordance with some examples of the present disclosure.

FIG. 5 illustrates 6-parameter affine model in accordance with some examples of the present disclosure.

FIG. 6 illustrates adjacent neighboring blocks for inherited affine merge candidates in accordance with some examples of the present disclosure.

FIG. 7 illustrates adjacent neighboring blocks for constructed affine merge candidates in accordance with some examples of the present disclosure.

FIG. 8 illustrates non-adjacent neighboring blocks for inherited affine merge candidates in accordance with some examples of the present disclosure.

FIG. 9 illustrates derivation of constructed affine merge candidates using non-adjacent neighboring blocks in accordance with some examples of the present disclosure.

FIG. 10 illustrates perpendicular scanning of non-adjacent neighboring blocks in accordance with some examples of the present disclosure.

FIG. 11 illustrates parallel scanning of non-adjacent neighboring blocks in accordance with some examples of the present disclosure.

FIG. 12 illustrates combined perpendicular and parallel scanning of non-adjacent neighboring blocks in accordance with some examples of the present disclosure.

FIG. 13A illustrates neighbor blocks with the same size as the current block in accordance with some examples of the present disclosure.

FIG. 13B illustrates neighbor blocks with a different size than the current block in accordance with some examples of the present disclosure.

FIG. 14A illustrates an example of the bottom-left or top-right block of the bottommost or rightmost block in a previous distance is used as the bottommost or rightmost block of a current distance in accordance with some examples of the present disclosure.

FIG. 14A illustrates an example of the left or top block of the bottommost or rightmost block in the previous distance is used as the bottommost or rightmost block of the current distance in accordance with some examples of the present disclosure.

FIG. 15A illustrates scanning positions at bottom-left and top-right positions used for above and left non-adjacent neighboring blocks in accordance with some examples of the present disclosure.

FIG. 15B illustrates scanning positions at bottom-right positions used for both above and left non-adjacent neighboring blocks in accordance with some examples of the present disclosure.

FIG. 15C illustrates scanning positions at bottom-left positions used for both above and left non-adjacent neighboring blocks in accordance with some examples of the present disclosure.

FIG. 15D illustrates scanning positions at top-right positions used for both above and left non-adjacent neighboring blocks in accordance with some examples of the present disclosure.

FIG. 16 illustrates a simplified scanning process for deriving constructed merge candidates in accordance with some examples of the present disclosure.

FIG. 17 is a diagram illustrating a computing environment coupled with a user interface in accordance with some examples of the present disclosure.

FIG. 18 is a flow chart illustrating a method for video coding in accordance with some examples of the present disclosure.

FIG. 19 is a flow chart illustrating a method for pruning an affine candidate in accordance with some examples of the present disclosure.

FIG. 20 is a block diagram illustrating a system for encoding and decoding video blocks in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g., devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

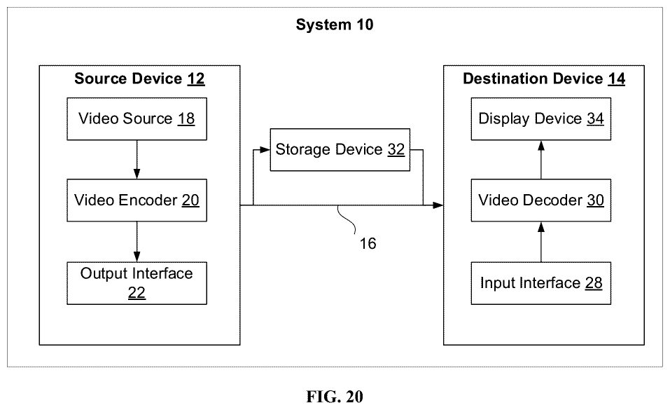

FIG. 20 is a block diagram illustrating an exemplary system 10 for encoding and decoding video blocks in parallel in accordance with some implementations of the present disclosure. As shown in FIG. 20, the system 10 includes a source device 12 that generates and encodes video data to be decoded at a later time by a destination device 14. The source device 12 and the destination device 14 may comprise any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 20, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

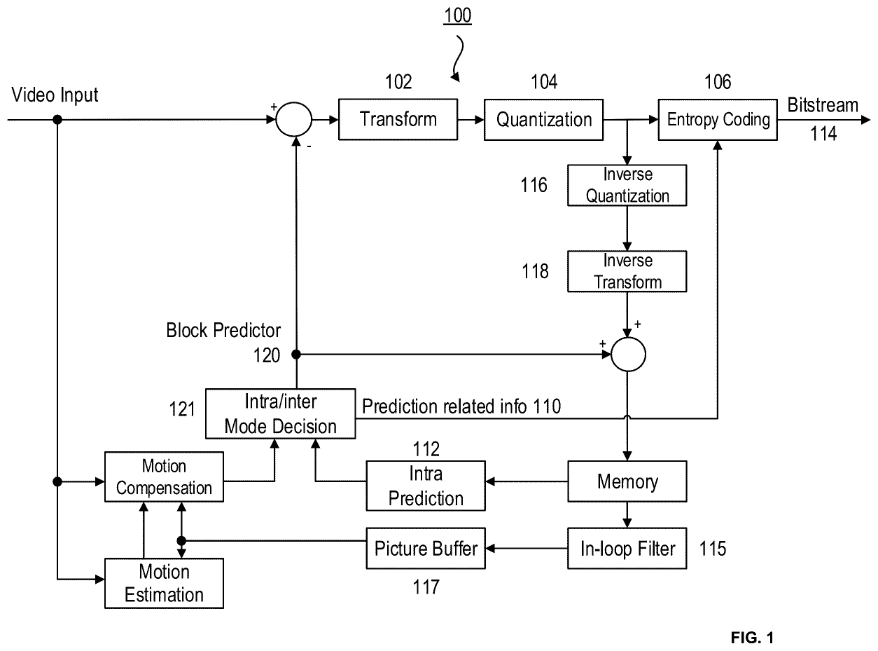

Like HEVC, VVC is built upon the block-based hybrid video coding framework. FIG. 1 is a block diagram illustrating a block-based video encoder in accordance with some implementations of the present disclosure. In the encoder 100, the input video signal is processed block by block, called coding units (CUs). The encoder 100 may be the video encoder 20 as shown in FIG. 20. In VTM-1.0, a CU can be up to 128×128 pixels. However, different from the HEVC which partitions blocks only based on quad-trees, in VVC, one coding tree unit (CTU) is split into CUs to adapt to varying local characteristics based on quad/binary/ternary-tree. Additionally, the concept of multiple partition unit type in the HEVC is removed, i.e., the separation of CU, prediction unit (PU) and transform unit (TU) does not exist in the VVC anymore; instead, each CU is always used as the basic unit for both prediction and transform without further partitions. In the multi-type tree structure, one CTU is firstly partitioned by a quad-tree structure. Then, each quad-tree leaf node can be further partitioned by a binary and ternary tree structure.

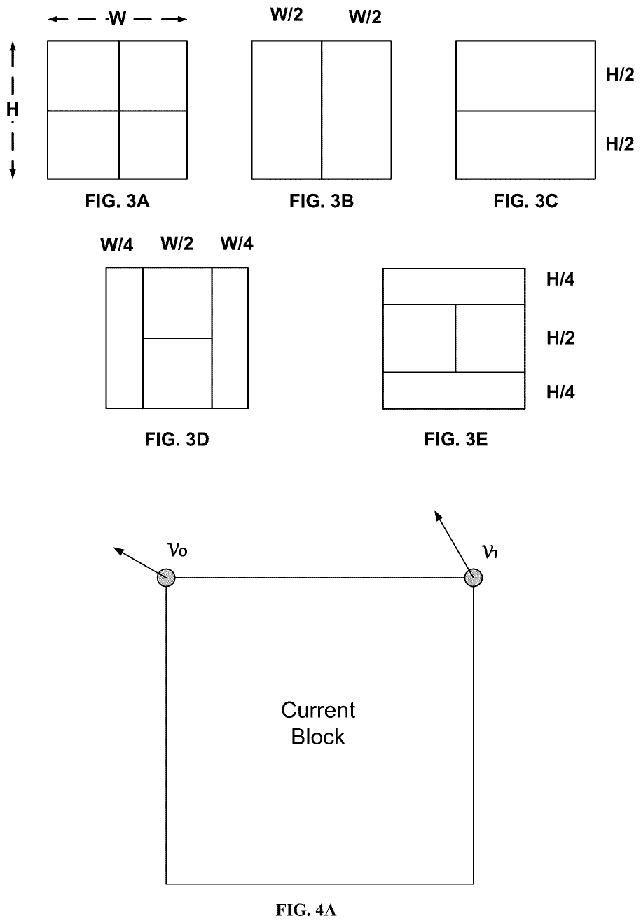

FIGS. 3A-3E are schematic diagrams illustrating multi-type tree splitting modes in accordance with some implementations of the present disclosure. FIGS. 3A-3E respectively show five splitting types including quaternary partitioning (FIG. 3A), vertical binary partitioning (FIG. 3B), horizontal binary partitioning (FIG. 3C), vertical extended ternary partitioning (FIG. 3D), and horizontal extended ternary partitioning (FIG. 3E).

For each given video block, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes.

After spatial and/or temporal prediction, an intra/inter mode decision circuitry 121 in the encoder 100 chooses the best prediction mode, for example based on the rate-distortion optimization method. The block predictor 120 is then subtracted from the current video block; and the resulting prediction residual is de-correlated using the transform circuitry 102 and the quantization circuitry 104. The resulting quantized residual coefficients are inverse quantized by the inverse quantization circuitry 116 and inverse transformed by the inverse transform circuitry 118 to form the reconstructed residual, which is then added back to the prediction block to form the reconstructed signal of the CU. Further, in-loop filtering 115, such as a deblocking filter, a sample adaptive offset (SAO), and/or an adaptive in-loop filter (ALF) may be applied on the reconstructed CU before it is put in the reference picture store of the picture buffer 117 and used to code future video blocks. To form the output video bitstream 114, coding mode (inter or intra), prediction mode information, motion information, and quantized residual coefficients are all sent to the entropy coding unit 106 to be further compressed and packed to form the bit-stream.

For example, a deblocking filter is available in AVC, HEVC as well as the now-current version of VVC. In HEVC, an additional in-loop filter called SAO is defined to further improve coding efficiency. In the now-current version of the VVC standard, yet another in-loop filter called ALF is being actively investigated, and it has a good chance of being included in the final standard.

These in-loop filter operations are optional. Performing these operations helps to improve coding efficiency and visual quality. They may also be turned off as a decision rendered by the encoder 100 to save computational complexity.

In some examples of the present disclosure, intra prediction is usually based on unfiltered reconstructed pixels, while inter prediction is based on filtered reconstructed pixels if these filter options are turned on by the encoder 100.

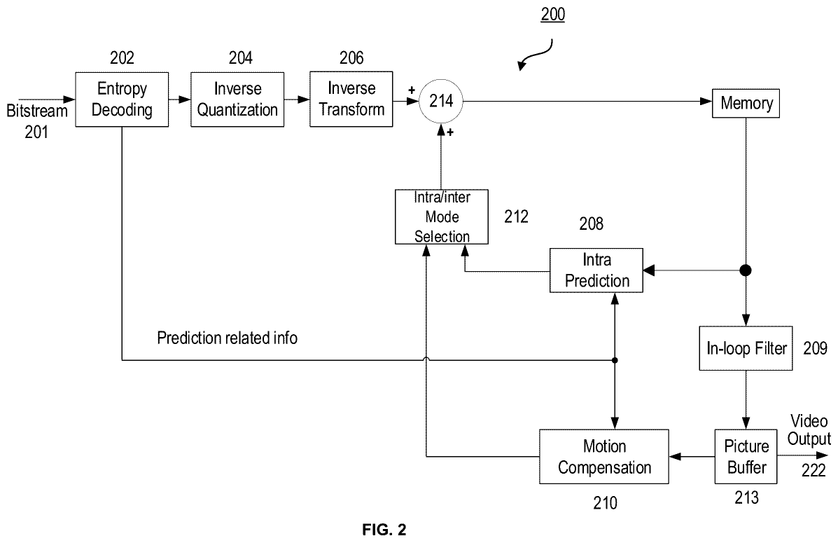

FIG. 2 is a block diagram illustrating a block-based video decoder 200 which may be used in conjunction with many video coding standards. This decoder 200 is similar to the reconstruction-related section residing in the encoder 100 of FIG. 1. The block-based video decoder 200 may be the video decoder 30 as shown in FIG. 20. In the decoder 200, an incoming video bitstream 201 is first decoded through an Entropy Decoding 202 to derive quantized coefficient levels and prediction-related information. The quantized coefficient levels are then processed through an Inverse Quantization 204 and an Inverse Transform 206 to obtain a reconstructed prediction residual. A block predictor mechanism, implemented in an Intra/inter Mode Selector 212, is configured to perform either an Intra Prediction 208, or a Motion Compensation 210, based on decoded prediction information. A set of unfiltered reconstructed pixels are obtained by summing up the reconstructed prediction residual from the Inverse Transform 206 and a predictive output generated by the block predictor mechanism, using a summer 214.

The reconstructed block may further go through an In-Loop Filter 209 before it is stored in a Picture Buffer 213 which functions as a reference picture store. The reconstructed video in the Picture Buffer 213 may be sent to drive a display device, as well as used to predict future video blocks. In situations where the In-Loop Filter 209 is turned on, a filtering operation is performed on these reconstructed pixels to derive a final reconstructed Video Output 222.

In the current VVC and AVS3 standards, motion information of the current coding block is either copied from spatial or temporal neighboring blocks specified by a merge candidate index or obtained by explicit signaling of motion estimation. The focus of the present disclosure is to improve the accuracy of the motion vectors for affine merge mode by improving the derivation methods of affine merge candidates. To facilitate the description of the present disclosure, the existing affine merge mode design in the VVC standard is used as an example to illustrate the proposed ideas. Please note that though the existing affine mode design in the VVC standard is used as the example throughout the present disclosure, in some other examples of the present disclosure, the proposed technologies can also be applied to a different design of affine motion prediction mode or other coding tools with the same or similar design spirit.

### Affine Model

In HEVC, only translation motion model is applied for motion compensated prediction. While in the real world, there are many kinds of motion, e.g., zoom in/out, rotation, perspective motions and other irregular motions. In the VVC and AVS3, affine motion compensated prediction is applied by signaling one flag for each inter coding block to indicate whether the translation motion model or the affine motion model is applied for inter prediction. In the current VVC and AVS3 design, two affine modes, including 4-paramter affine mode and 6-parameter affine mode, are supported for one affine coding block.

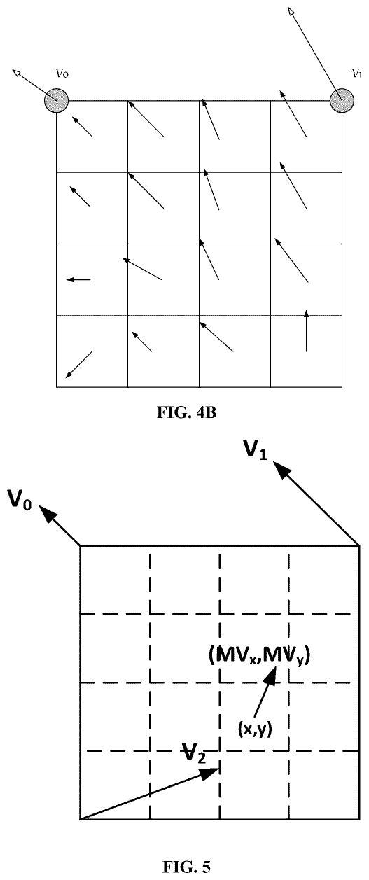

The 4-parameter affine model has the following parameters: two parameters for translation movement in horizontal and vertical directions respectively, one parameter for zoom motion and one parameter for rotational motion for both directions. In this model, horizontal zoom parameter is equal to vertical zoom parameter, and horizontal rotation parameter is equal to vertical rotation parameter. To achieve a better accommodation of the motion vectors and affine parameter, those affine parameters are to be derived from two MVs (which are also called control point motion vector (CPMV)) located at the top-left corner and top-right corner of a current block. As shown in FIGS. 4A-4B, the affine motion field of the block is described by two CPMVs (V₀, V₁). Based on the control point motion, the motion field (vₓ, v_{y}) of one affine coded block is described as

$${v}_{x} = \frac{( {v}_{1 x} - {v}_{0 x} )}{w} x - \frac{( {v}_{1 y} - {v}_{0 y} )}{w} y + {v}_{0 x} \qquad ( 1 )$$

$${v}_{y} = \frac{( {v}_{1 y} - {v}_{0 y} )}{w} x + \frac{( {v}_{1 x} - {v}_{0 x} )}{w} y + {v}_{0 y}$$

The 6-parameter affine mode has the following parameters: two parameters for translation movement in horizontal and vertical directions respectively, two parameters for zoom motion and rotation motion respectively in horizontal direction, another two parameters for zoom motion and rotation motion respectively in vertical direction. The 6-parameter affine motion model is coded with three CPMVs. As shown in FIG. 5, the three control points of one 6-paramter affine block are located at the top-left, top-right and bottom left corner of the block. The motion at top-left control point is related to translation motion, and the motion at top-right control point is related to rotation and zoom motion in horizontal direction, and the motion at bottom-left control point is related to rotation and zoom motion in vertical direction. Compared to the 4-parameter affine motion model, the rotation and zoom motion in horizontal direction of the 6-paramter may not be same as those motion in vertical direction. Assuming (V₀, V₁, V₂) are the MVs of the top-left, top-right and bottom-left corners of the current block in FIG. 5, the motion vector of each sub-block (vₓ, v_{y}) is derived using the three MVs at control points as:

$${v}_{x} = {v}_{0 x} + ( {v}_{1 x} - {v}_{0 x} ) * \frac{x}{w} + ( {v}_{2 x} - {v}_{0 x} ) * \frac{y}{h} \qquad ( 2 )$$

$${v}_{y} = {v}_{0 y} + ( {v}_{1 y} - {v}_{0 y} ) * \frac{x}{w} + ( {v}_{2 y} - {v}_{0 y} ) * \frac{y}{h}$$

### Affine Merge Mode

In affine merge mode, the CPMVs for the current block are not explicitly signaled but derived from neighboring blocks. Specifically, in this mode, motion information of spatial neighbor blocks is used to generate CPMVs for the current block. The affine merge mode candidate list has a limited size. For example, in the current VVC design, there may be up to five candidates. The encoder may evaluate and choose the best candidate index based on rate-distortion optimization algorithms. The chosen candidate index is then signaled to the decoder side. The affine merge candidates can be decided in three ways. In the first way, the affine merge candidates may be inherited from neighboring affine coded blocks. In the second way, the affine merge candidates may be constructed from translational MVs from neighboring blocks. In the third way, zero MVs are used as the affine merge candidates.

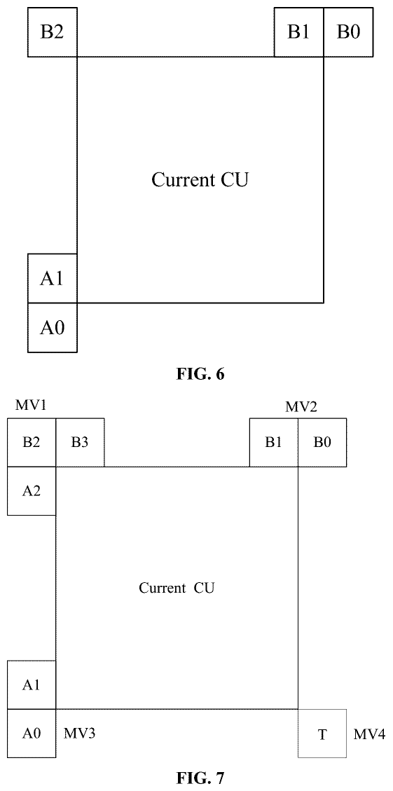

For the inherited method, there may be up to two candidates. The candidates are obtained from the neighboring blocks located at the bottom-left of the current block (e.g., scanning order is from A0 to A1 as shown in FIG. 6) and from the neighboring blocks located at the top-right of the current block (e.g., scanning order is from B0 to B2 as shown in FIG. 6), if available.

For the constructed method, the candidates are the combinations of neighbor's translational MVs, which may be generated by two steps.

Step 1: obtain four translational MVs including MV1, MV2, MV3 and MV4 from available neighbors.
MV1: MV from the one of the three neighboring blocks close to the top-left corner of the current block. As shown in FIG. 7, the scanning order is B2, B3 and A2.
MV2: MV from the one of the one from the two neighboring blocks close to the top-right corner of the current block. As shown in FIG. 7, the scanning order is B1 and B0.
MV3: MV from the one of the one from the two neighboring blocks close to the bottom-left corner of the current block. As shown in FIG. 7, the scanning order is A1 and A0.
MV4: MV from the temporally collocated block of the neighboring block close to the bottom-right corner of current block. As shown in the FIG., the neighboring block is T.

Step 2: derive combinations based on the four translational MVs from Step 1.
Combination 1: MV1, MV2, MV3;
Combination 2: MV1, MV2, MV4;
Combination 3: MV1, MV3, MV4;
Combination 4: MV2, MV3, MV4;
Combination 5: MV1, MV2;
Combination 6: MV1, MV3.

When the merge candidate list is not full after filling with inherited and constructed candidates, zero MVs are inserted at the end of the list.

For the current video standards VVC and AVS, only adjacent neighboring blocks are used to derive affine merge candidates for the current block, as shown in FIG. 6 and FIG. 7 for inherited candidates and constructed candidates respectively. To increase the diversity of merge candidates and further explore spatial correlations, it is straightforward to extend the coverage of neighboring blocks from adjacent areas to non-adjacent areas.

In the present disclosure, the candidate derivation process for affine merge mode is extended by using not only adjacent neighboring blocks but also non-adjacent neighboring blocks. Detailed methods may be summarized in three aspects including affine merge candidate pruning, non-adjacent neighbor based derivation process for affine inherited merge candidates and non-adjacent neighbor based derivation process for affine constructed merge candidates.

### Affine Merge Candidate Pruning

As the affine merge candidate list in a typical video coding standards usually has a limited size, candidate pruning is an essential process to remove redundant ones. For both affine merge inherited candidates and constructed candidates, this pruning process is needed. As explained in the introduction section, CPMVs of a current block are not directly used for affine motion compensation. Instead, CPMVs need to be converted into translational MVs at the location of each sub-block within the current block. The conversion process is performed by following a general affine model as shown below:

$$\{ \begin{matrix}{v}_{x} ( x , y ) = a + c * x + d * y \\ {v}_{y} ( x , y ) = b + e * x + f * y\end{matrix} \qquad ( 3 )$$

where (a, b) are delta translation parameters, (c, d) are delta zoom and rotation parameters for horizontal direction, (e,f) are delta zoom and rotation parameters for vertical direction, (x,y) are the horizontal and vertical distance of the pivot location (e.g., the center or top-left corner) of a sub-block relative to the top-left corner of the current block (e.g., the coordinate (x,y) shown in FIG. 5), and (Vₓ, v_{y}) is the target translational MVs of the sub-block.

For 6-parameter affine model, three CPMVs, termed as V₀, V₁ and V₂, are available. Then the six model parameters a, b, c, d, e and f can be calculated as

$$\{ \begin{matrix}a = {v}_{0 x} \\ b = {v}_{0 y} \\ c = ( {v}_{1 x} - {v}_{0 x} ) / w \\ d = ( {v}_{2 x} - {v}_{0 x} ) / h \\ e = ( {v}_{1 y} - {v}_{0 y} ) / w \\ f = ( {v}_{2 y} - {v}_{0 y} ) / h\end{matrix} \qquad ( 4 )$$

For 4-parameter affine model, if top-left corner CPMV and top-right corner CPMV, termed as V₀ and V₁, are available, the six parameters of a, b, c, d, e and f can be calculated as

$$\{ \begin{matrix}a = {v}_{0 x} \\ b = {v}_{0 y} \\ c = ( {v}_{1 x} - {v}_{0 x} ) / w \\ d = - ( {v}_{1 y} - {v}_{0 y} ) / w \\ e = ( {v}_{1 y} - {v}_{0 y} ) / w \\ f = ( {v}_{1 x} - {v}_{0 x} ) / w\end{matrix} \qquad ( 5 )$$

For 4-parameter affine model, if top-left corner CPMV and bottom-left corner CPMV, termed as V₀ and V₂, are available, the six parameters of a, b, c, d, e and f can be calculated as

$$\{ \begin{matrix}a = {v}_{0 x} \\ b = {v}_{0 y} \\ c = ( {v}_{2 y} - {v}_{0 y} ) / h \\ d = ( {v}_{2 x} - {v}_{0 x} ) / h \\ e = - ( {v}_{2 x} - {v}_{0 x} ) / h \\ f = ( {v}_{2 y} - {v}_{0 y} ) / h\end{matrix} \qquad ( 6 )$$

In above equations (4), (5), and (6), w and h represent the width and height of the current block, respectively.

When two merge candidate sets of CPMVs are compared for redundancy check, it is proposed to check the similarity of the 6 affine model parameters. Therefore, the candidate pruning process can be performed in two steps.

In Step 1, given two candidate sets of CPMVs, the corresponding affine model parameters for each candidate set are derived. More specifically, the two candidate sets of CPMVs may be represented by two sets of affine model parameters, e.g., (a₁, b₁, C₁, d₁, e₁, f₁) and (a₂, b₂, C₂, d₂, e₂, f₂).

In Step 2, based on one or more pre-defined threshold values, similarity check is performed between the two sets of affine model parameters. In one embodiment, when the absolute values of (a₁−a₂), (b₁− b₂), (C₁− C₂), (d₁−d2), (e₁−e₂) and (f₁−f₂) are all below a positive threshold value, such as the value of 1, the two candidates are considered to be similar and one of them can be pruned/removed and not put in the merge candidate list.

In some embodiments, the divisions or right shift operations in Step 1 may be removed to simplify the calculations in the CPMV pruning process.

Specifically, the model parameters of c, d, e and f may be calculated without being divided by the width w and height h of the current block. For example, take above equation (4) as an example, the approximated model parameters of c′, d′, e′ and f′ may be calculated as below equation (7).

$$\{ \begin{matrix}{c}^{′} = ( {v}_{1 x} - {v}_{0 x} ) \\ {d}^{′} = ( {v}_{2 x} - {v}_{0 x} ) \\ {e}^{′} = ( {v}_{1 y} - {v}_{0 y} ) \\ {f}^{′} = ( {v}_{2 y} - {v}_{0 y} )\end{matrix} \qquad ( 7 )$$

In the case that only two CPMVs are available, part of the model parameters is derived from the other part of the model parameters, which are dependent on the width or height of the current block. In this case, the model parameters may be converted to take the impact of the width and height into account. For example, in the case of the equation (5), the approximated model parameters of c′, d′, e′ and f′ may be calculated based on equation (8) below. In the case of the equation (6), the approximated model parameters of c′, d′, e′ and f′ may be calculated based on equation (9) below.

$$\{ \begin{matrix}{c}^{′} = ( {v}_{1 x} - {v}_{0 x} ) \\ {e}^{′} = ( {v}_{1 y} - {v}_{0 y} ) \\ {d}^{′} = - ( {e}^{′} * h / w ) \\ {f}^{′} = {c}^{′} * h / w\end{matrix} \qquad ( 8 )$$

$$\{ \begin{matrix}{d}^{′} = ( {v}_{2 x} - {v}_{0 x} ) \\ {f}^{′} = ( {v}_{2 y} - {v}_{0 y} ) \\ {c}^{′} = {f}^{′} * w / h \\ {e}^{′} = - ( {d}^{′} * w / h )\end{matrix} \qquad ( 9 )$$

When the approximated model parameters of c′, d′, e′ and f′ are calculated in above Step 1, the calculation of the absolute values that are needed for similarity check in the Step 2 above may be changed accordingly: (a₁−a₂), (b₁−b₂), (c₁−c₂), (d₁−d₂), (e, −e₂) and (f, −f₂).

In the Step 2 above, threshold values are needed to evaluate the similarity between two candidate sets of CPMV. There may be multiple ways to define the threshold values. In one embodiment, the threshold values may be defined per comparable parameter. Table 1 is one example in this embodiment showing threshold values defined per comparable model parameter. In another embodiment, the threshold values may be defined by considering the size of the current coding block. Table 2 is one example in this embodiment showing threshold values defined by the size of the current coding block.

TABLE 1

| Comparable parameter | Threshold value |
|---|---|
| a | 1 |
| b | 1 |
| c | 2 |
| d | 2 |
| e | 2 |
| f | 2 |

TABLE 2

| Size of the current block | Threshold value |
|---|---|
| Size <= 64 pixels | 1 |
| 64 pixels < Size <= 256 pixels | 2 |
| 256 pixels < Size <= 1024 pixels | 4 |
| 1024 pixels < Size | 8 |

In another embodiment, the threshold values may be defined by considering the weight or the height of the current block. Table 3 and Table 4 are examples in this embodiment. Table 3 shows threshold values defined by the width of the current coding block and Table 4 shows threshold values defined by the height of the current coding block.

TABLE 3

| Width of the current block | Threshold value |
|---|---|
| Width <= 8 pixels | 1 |
| 8 pixels < Width <= 32 pixels | 2 |
| 32 pixels < Width <= 64 pixels | 4 |
| 64 pixels < Width | 8 |

TABLE 4

| Height of the current block | Threshold value |
|---|---|
| Height <= 8 pixels | 1 |
| 8 pixels < Height <= 32 pixels | 2 |
| 32 pixels < Height <= 64 pixels | 4 |
| 64 pixels < Height | 8 |

In another embodiment, the threshold values may be defined as a group of fixed values. In another embodiment, the threshold values may be defined by any combinations of above embodiments. In one example, the threshold values may be defined by considering different parameters and the weight and the height of the current block. Table 5 is one example in this embodiment showing threshold values defined by the height of the current coding block. Note that in any above proposed embodiments, the comparable parameters, if needed, may represent any parameters defined in any equations from equation (4) to equation (9).

TABLE 5

| Comparable parameter | Threshold value |
|---|---|
| a | 1 |
| b | 1 |
| c | Width <= 8 pixels: 1 |
| e | 8 pixels < Width <= 32 pixels: 2 |
| | 32 pixels < Width <= 64 pixels: 4 |
| | 64 pixels < Width: 8 |
| d | Height <= 8 pixels: 1 |
| f | 8 pixels < Height <= 32 pixels: 2 |
| | 32 pixels < Height <= 64 pixels: 4 |
| | 64 pixels < Height: 8 |

The benefits of using the converted affine model parameters for candidate redundancy check include that: it creates a unified similarity check process for candidates with different affine model types, e.g., one merge candidate may user 6-parameter affine model with three CPMVs while another candidate may use 4-parameter affine model with two CPMVs; it considers the different impacts of each CPMV in a merge candidate when deriving the target MV at each sub-block; and it provides the similarity significance of two affine merge candidates related to the width and height of the current block.

### Non-Adjacent Neighbor Based Derivation Process for Affine Inherited Merge Candidates

For inherited merge candidates, non-adjacent neighbor based derivation process may be performed in three steps. Step 1 is for candidate scanning. Step 2 is for CPMV projection. Step 3 is for candidate pruning.

In Step 1, non-adjacent neighboring blocks are scanned and selected by following methods.

### Scanning Area and Distance

In some examples, non-adjacent neighboring blocks may be scanned from left area and above area of the current coding block. The scanning distance may be defined as the number of coding blocks from the scanning position to the left side or top side of the current coding blocks.

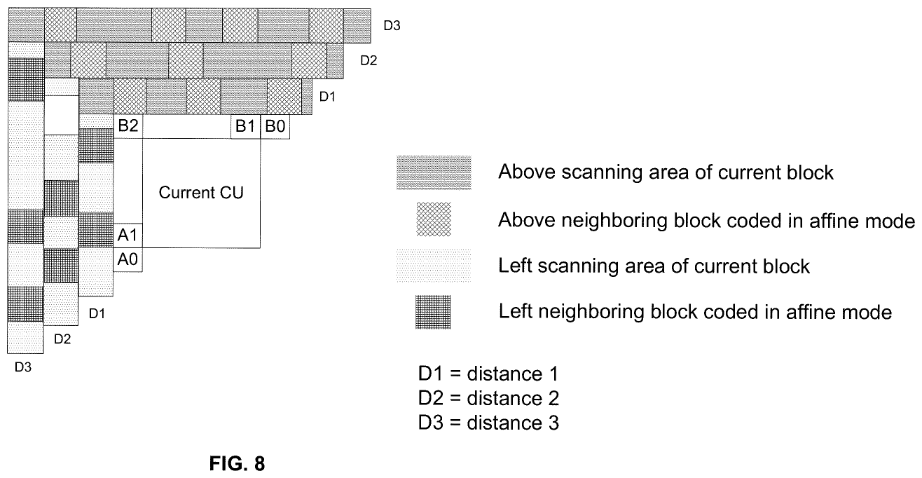

As shown in FIG. 8, on either the left or above of the current coding block, multiple lines of non-adjacent neighboring blocks may be scanned. The distance shown in FIG. 8 represents the number of coding blocks from each candidate position to the left side or top side of the current block. For example, the area with “distance 2” on the left side of the current block indicates that the candidate neighboring blocks located in this area are 2 blocks away from the current block. Similar indications may be applied to other scanning areas with different distances.

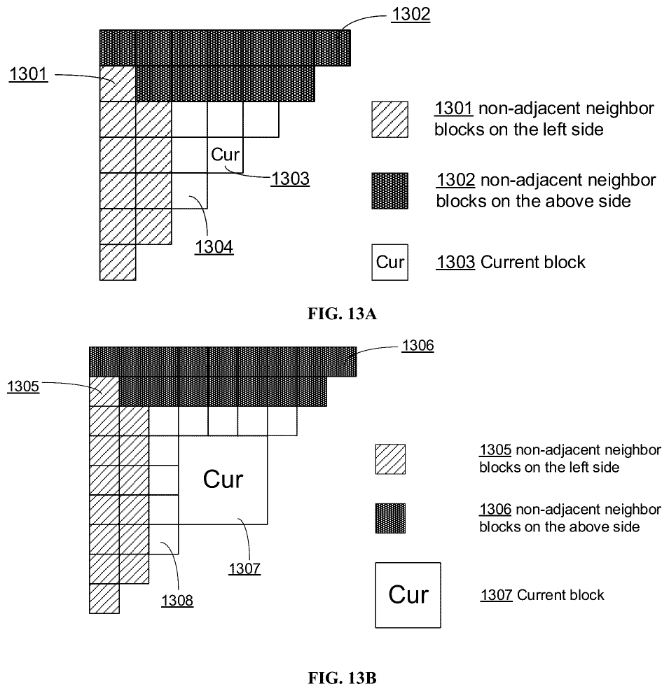

In one or more embodiments, the non-adjacent neighboring blocks at each distance may have the same block size as the current coding block, as shown in the FIG. 13A. As shown in FIG. 13A, the non-adjacent neighbor blocks 1301 on the left side and the non-adjacent neighbor blocks 1302 on the above side have the same size as the current block 1303. In some embodiments, the non-adjacent neighboring blocks at each distance may have a different block size as the current coding block, as shown in the FIG. 13B. The neighbor block 1304 is an adjacent neighbor block to the current block 1303. As shown in FIG. 13B, the non-adjacent neighbor blocks 1305 on the left side and the non-adjacent neighbor blocks 1306 on the above side have the same size as the current block 1307. The neighbor block 1308 is an adjacent neighbor block to the current block 1307.

Note that when the non-adjacent neighboring blocks at each distance have the same block size as the current coding block, the value of the block size is adaptively changed according to the partition granularity at each different area in an image. Note that when the non-adjacent neighboring blocks at each distance have a different block size as the current coding block, the value of the block size may be predefined as a constant value, such as 4×4, 8×8 or 16×16.

Based on the defined scanning distance, the total size of the scanning area on either the left or above of the current coding clock may be determined by a configurable distance value. In one or more embodiments, the maximum scanning distance on the left side and above side may use a same value or different values. FIG. 13 shows an example where the maximum distance on both the left side and above side shares a same value of 2. The maximum scanning distance value(s) may be determined by the encoder side and signaled in a bitstream. Alternatively, the maximum scanning distance value(s) may be predefined as fixed value(s), such as the value of 2 or 4. When the maximum scanning distance is predefined as the value of 4, it indicates that the scanning process is terminated when the candidate list is full or all the non-adjacent neighboring blocks with at most distance 4 have been scanned, whichever comes first.

In one or more embodiments, within each scanning area at a specific distance, the starting and ending neighboring blocks may be position dependent.

In some embodiments, for the left side scanning areas, the starting neighboring blocks may be the adjacent bottom-left block of the starting neighboring block of the adjacent scanning area with smaller distance. For example, as shown in FIG. 8, the starting neighboring block of the “distance 2” scanning area on the left side of the current block is the adjacent bottom-left neighboring block of the starting neighboring block of the “distance 1” scanning area. The ending neighboring blocks may be the adjacent left block of the ending neighboring block of the above scanning area with smaller distance. For example, as shown in FIG. 8, the ending neighboring block of the “distance 2” scanning area on the left side of the current block is the adjacent left neighboring block of the ending neighboring block of the “distance 1” scanning area above the current block.

Similarly, for the above side scanning areas, the starting neighboring blocks may be the adjacent top-right block of the starting neighboring block of the adjacent scanning area with smaller distance. The ending neighboring blocks may be the adjacent top-left block of the ending neighboring block of the adjacent scanning area with smaller distance.

### Scanning Order

When the neighboring blocks are scanned in the non-adjacent areas, certain order or/and rules may be followed to determine the selections of the scanned neighboring blocks.

In some embodiments, the left area may be scanned first, and then followed by scanning the above areas. As shown in FIG. 8, three lines of non-adjacent areas (e.g., from distance 1 to distance 3) on the left side may be scanned first, then followed by scanning the three lines of non-adjacent areas above the current block.

In some embodiments, the left areas and above areas may be scanned alternatively. For example, as shown in FIG. 8, the left scanning area with “distance 1” is scanned first, then followed by the scanning the above area with “distance 1.”

For scanning areas located on the same side (e.g., left or above areas), the scanning order is from the areas with small distance to the areas with large distance. This order may be flexibly combined with other embodiments of scanning order. For example, the left and above areas may be scanned alternatively, and the order for same side areas is scheduled to be from small distance to large distance.

Within each scanning area at a specific distance, a scanning order may be defined. In one embodiment, for the left scanning areas, the scanning may be started from the bottom neighboring block to the top neighboring block. For the above scanning areas, the scanning may be started from the right block to the left block.

### Scanning Termination

For inherited merge candidates, the neighboring blocks coded with affine mode are defined as qualified candidates. In some embodiments, the scanning process may be performed interactively. For example, the scanning performed in a specific area at a specific distance may be stopped at the instance when first X qualified candidates are identified, where X is a predefined positive value. For example, as shown in FIG. 8, the scanning in the left scanning area with distance 1 may be stopped when the first one or more qualified candidates are identified. Then the next iteration of scanning process is started by targeting at another scanning area, which is regulated by a pre-defined scanning order/rule.

In some embodiments, the scanning process may be performed continuously. For example, the scanning performed in a specific area at a specific distance may be stopped at the instance when all covered neighboring blocks are scanned and no more qualified candidates are identified or the maximum allowable number of candidates is reached.

During the candidate scanning process, each candidate non-adjacent neighboring block is determined and scanned by following the above proposed scanning methods. For easier implementation, each candidate non-adjacent neighboring block may be indicated or located by a specific scanning position. Once a specific scanning area and distance are decided by following above proposed methods, the scanning positions may be determined accordingly based on following methods.

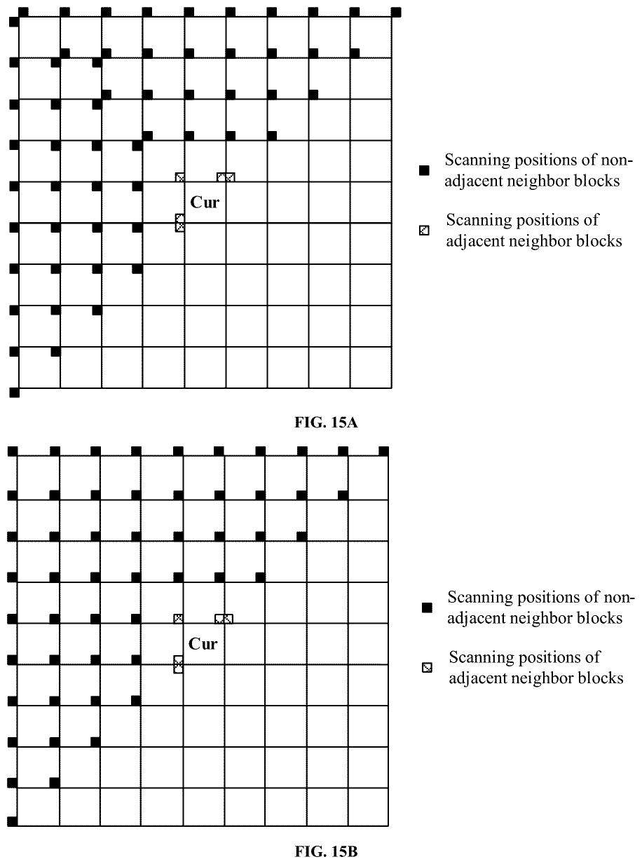

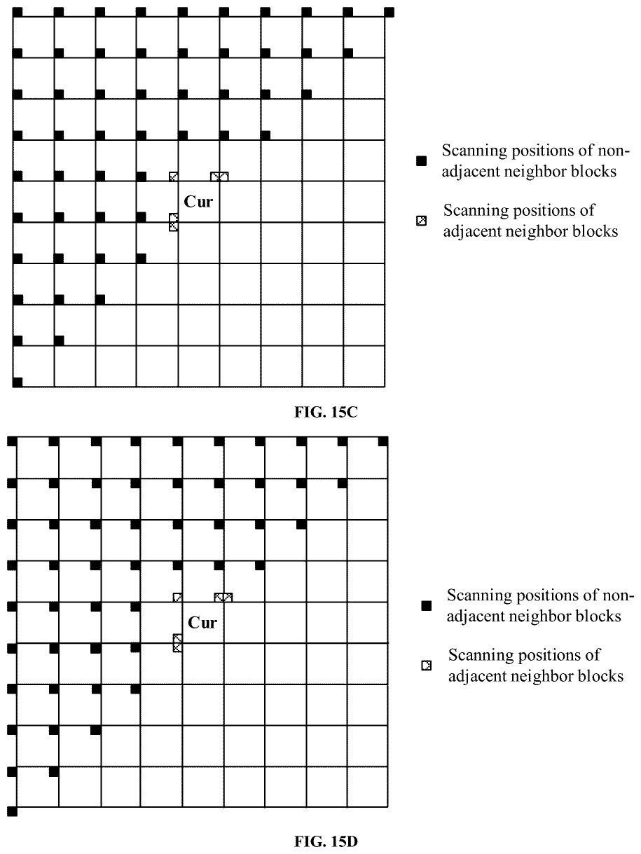

In one method, bottom-left and top-right positions are used for above and left non-adjacent neighboring blocks respectively, as shown in FIG. 15A.

In another method, bottom-right positions are used for both above and left non-adjacent neighboring blocks, as shown in FIG. 15B.

In another method, bottom-left positions are used for both above and left non-adjacent neighboring blocks, as shown in FIG. 15C.

In another method, top-right positions are used for both above and left non-adjacent neighboring blocks, as shown in FIG. 15D.

For easier illustration, in FIGS. 15A-15D, each non-adjacent neighboring block is assumed to have the same block size as the current block. Without loss of generality, this illustration may be easily extended to non-adjacent neighboring blocks with different block sizes.

Further, in Step 2, the same process of CPMV projection as used in the current AVS and VVC standards may be utilized. In this CPMV projection process, the current block is assumed to share the same affine model with the selected neighboring block, then two or three corner pixel's coordinates (e.g., if the current block uses 4-parameter model, two coordinates (top-left pixel/sample location and top-right pixel/sample location) are used; if the current block uses 6-parameter model, three coordinates (top-left pixel/sample location, top-right pixel/sample location and bottom-left pixel/sample location) are used) are plugged into equation (1) or (2), which depends on whether the neighboring block is coded with a 4-parameter or 6-parameter affine model, to generate two or three CPMVs.

In Step 3, any qualified candidate that is identified in Step 1 and converted in Step 2 may go through a similarity check against all existing candidates that are already in the merge candidate list. The details of similarity check are already described in the section of Affine Merge Candidate Pruning above. If the newly qualified candidate is found to be similar with any existing candidate in the candidate list, this newly qualified candidate is removed/pruned.

### Non-Adjacent Neighbor Based Derivation Process for Affine Constructed Merge Candidates

In the case of deriving inherited merge candidates, one neighboring block is identified at one time, where this single neighboring block needs to be coded in affine mode and may contain two or three CPMVs. In the case of deriving constructed merge candidates, two or three neighboring blocks may be identified at one time, where each identified neighboring block does not need to be coded in affine mode and only one translational MV is retrieved from this block.

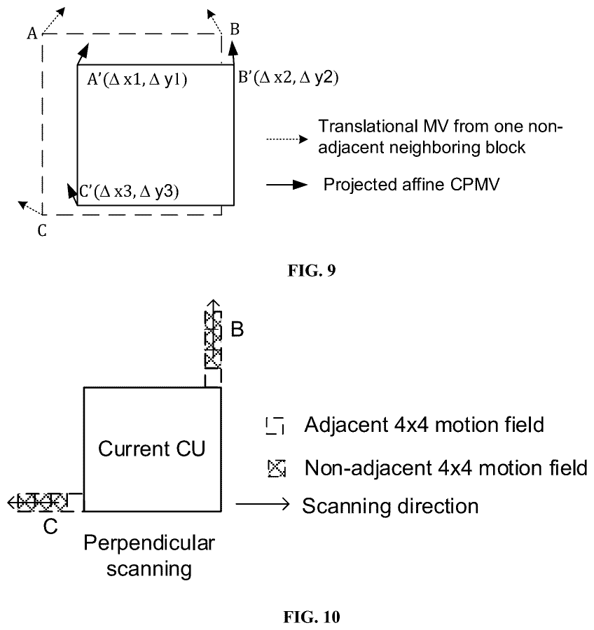

FIG. 9 presents an example where constructed affine merge candidates may be derived by using non-adjacent neighboring block. In FIGS. 9, A, B and C are the geographical positions of three non-adjacent neighboring blocks. A virtual coding block is formed by using the position of A as the top-left corner, the position of B as the top-right corner, and the position of C as the bottom-left corner. If considering the virtual CU as an affine coded block, the MVs at the positions of A′, B′ and C′ may be derived by following the equation (3), where the model parameters (a, b, c, d, e, f) may be calculated by the translational MV at the positions of A, B and C. Once derived, the MVs at positions of A′, B′ and C′ may be used as the three CPMVs for the current block, and the existing process (the one used in the AVS and VVC standards) of generating constructed affine merge candidates may be used.

For constructed merge candidates, non-adjacent neighbor based derivation process may be performed in five steps. The non-adjacent neighbor based derivation process may be performed in the five steps in an apparatus such as an encoder or a decoder. Step 1 is for candidate scanning. Step 2 is for affine model determination. Step 3 is for CPMV projection. Step 4 is for candidate generation. And Step 5 is for candidate pruning. In Step 1, non-adjacent neighboring blocks may be scanned and selected by following methods.

### Scanning Area and Distance

In some embodiments, to maintain a rectangular coding block, the scanning process is only performed for two non-adjacent neighboring blocks. The third non-adjacent neighboring block may be dependent on the horizontal and vertical positions of the first and second non-adjacent neighboring blocks.

In some embodiments, as shown in FIG. 9, the scanning process is only performed for the positions of B and C. The position of A may be uniquely determined by the horizontal position of C and the vertical position of B. In this case, the scanning area and distance may be defined according to a specific scanning direction.

In some embodiments, the scanning direction may be perpendicular to the side of the current block. One example is shown in FIG. 10, where the scanning area is defined as one line of continuous motion fields on the left or above the current block. The scanning distance is defined as the number of motion fields from the scanning position to the side of the current block. Note that the size of the motion filed may be dependent on the max granularity of the applicable video coding standards. In the example shown in FIG. 10, the size of the motion field is assumed to be aligned with the current VVC standards and set to be 4×4.

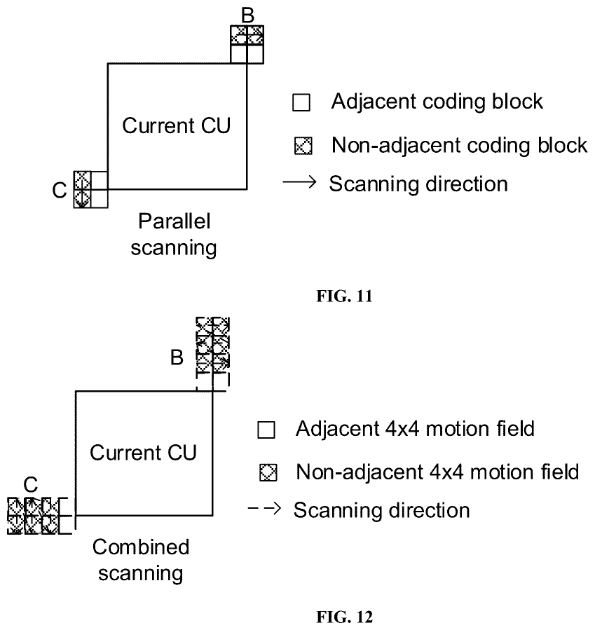

In some embodiments, the scanning direction may be parallel to the side of the current block. One example is shown in FIG. 11, where the scanning area is defined as the one line of continuous coding blocks on the left or above the current block.

In some embodiments, the scanning direction may be a combination of perpendicular and parallel scanning to the side of the current block. One example is shown in FIG. 12. As shown in FIG. 12, the scanning direction may be also a combination of parallel and diagonal. Scanning at position B starts from left to right, and then in a diagonal direction to the left and upper block. The scanning at position B will repeat as shown in FIG. 12. Similarly, scanning at position C starts from top to bottom, and then in a diagonal direction to the left and upper block. The scanning at position C will repeat as shown in FIG. 12.

### Scanning Order

In some embodiments, the scanning order may be defined as from the positions with smaller distance to the positions with larger distance to the current coding block. This order may be applied to the case of perpendicular scanning.

In some embodiments, the scanning order may be defined as a fixed pattern. This fix-pattern scanning order may be used for the candidate positions with similar distance. One example is the case of parallel scanning. In one example, the scanning order may be defined as top-down direction for the left scanning area, and may be defined as from left to right directions for the above scanning areas, like the example shown in FIG. 11.

For the case of the combined scanning method, the scanning order may be a combination of fix-pattern and distance dependent, like the example shown in FIG. 12.

### Scanning Termination

For constructed merge candidates, the qualified candidate does not need to be affine coded since only translational MV is needed.

Dependent on the required number of candidates, the scanning process may be terminated when the first X qualified candidates are identified, where X is a positive value.

As shown in FIG. 9, in order to form a virtual coding block, three corners named as A, B and C are needed. For easier implementation, the scanning process in Step 1 may be only performed for identifying the non-adjacent neighboring blocks located at corner B and C, while the coordinate of A may be precisely determined by taking the horizontal coordinate of C and the vertical coordinate of B. In this way, the formed virtual coding block is restricted to be rectangle. In the case when either B or C point is unavailable, e.g., out of boundary, or the motion information at the non-adjacent neighboring blocks corresponding to B or C is unavailable, the horizontal coordinate or vertical coordinate of C may be defined as the horizontal coordinate or vertical coordinate of the top-left point of the current block respectively.

For unification purpose, the methods of defining scanning area and distance, scanning order, and scanning termination proposed for deriving inherited merge candidates may completely or partially reused for deriving constructed merge candidates. In one or more embodiments, the same methods defined for inherited merge candidate scanning, which include but no limited to scanning area and distance, scanning order and scanning termination, may be completely reused for constructed merge candidate scanning.

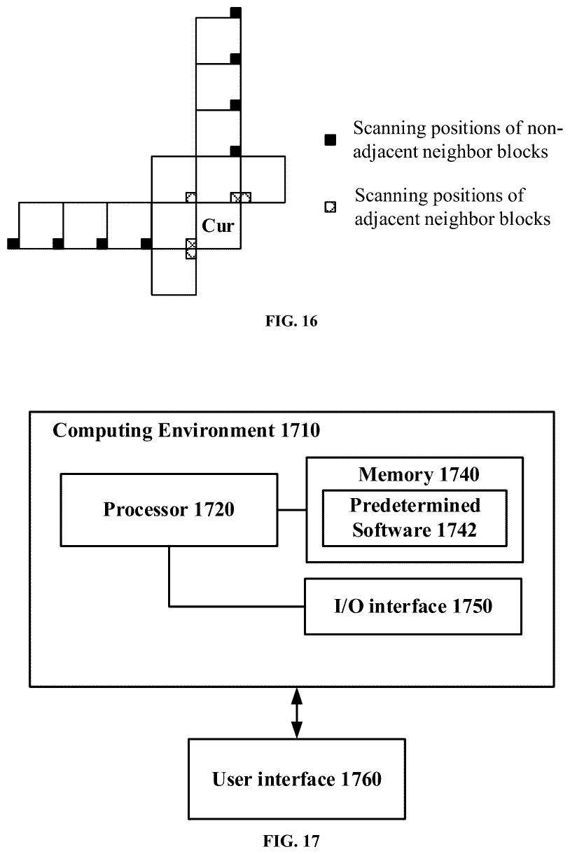

In some embodiments, the same methods defined for inherited merge candidate scanning, may be partly reused for constructed merge candidate scanning. FIG. 16 shows an example in this case. In FIG. 16, the block size of each non-adjacent neighboring blocks is same as the current block, which is similarly defined as inherited candidate scanning, but the whole process is a simplified version since the scanning at each distance is limited to be only one block.

In Step 2, the translational MVs at the positions of the selected candidates after step 1 are evaluated and an appropriate affine model may be determined. For easier illustration and without loss of generality, FIG. 9 is used as an example again.

Due to factors such as hardware constrains, implementation complexity and different reference indexes, the scanning process may be terminated before enough number of candidates are identified. For example, the motion information of the motion field at one or more of the selected candidates after Step 1 may be unavailable.

If the motion information of all three candidates are available, the corresponding virtual coding block represents a 6-parameter affine model. If the motion information of one of the three candidates is unbailable, the corresponding virtual coding block represents a 4-parameter affine model. If the motion information of more than one of the three candidates is unbailable, the corresponding virtual coding block may be unable to represent a valid affine model.

In some embodiments, if the motion information at the top-left corner, e.g., the corner A in FIG. 9, of the virtual coding block is unavailable, or the motion information at both the top-right corner, e.g., the corner B in FIG. 9, and bottom-left corner, e.g., the corner C in the FIG. 9, is unavailable, the virtual block may be set to be invalid and unable to represent a valid model, then Step 3 and Step 4 may be skipped for the current iteration.

In some embodiments, if either the top-right corner, e.g., the corner B in the FIG. 9, or bottom-left corner, e.g., the corner C in FIG. 9, is unavailable, but not both are unavailable, the virtual block may represent a valid 4-parameter affine model.

In Step 3, if the virtual coding block is able to represent a valid affine model, the same projection process used for inherited merge candidate may be used.

In one or more embodiments, the same projection process used for inherited merge candidate may be used. In this case, a 4-parameter model represented by the virtual coding block from Step 2 is projected to a 4-parameter model for the current block, and a 6-parameter model represented by the virtual coding block from Step 2 is projected to a 6-parameter model for the current block.

In some embodiments, the affine model represented by the virtual coding block from Step 2 is always projected to a 4-parameter model or a 6-parameter model for the current block.

Note that according to equation (5) and (6), there may be two types of 4-parameter affine model, where the type A is that the top-left corner CPMV and top-right corner CPMV, termed as V₀ and V₁, are available, and the type B is that the top-left corner CPMV and bottom-left corner CPMV, termed as V₀ and V₂, are available.

In one or more embodiments, the type of the projected 4-parameter affine model is the same type of the 4-parameter affine model represented by the virtual coding block. For example, the affine model represented by the virtual coding block from Step 2 is type A or B 4-parameter affine model, then the projected affine model for the current block is also type A or B respectively.

In some embodiments, the 4-parameter affine model represented by the virtual coding block from Step 2 is always projected to the same type of 4-parameter model for the current block. For example, the type A or B of 4-parameter affine model represented by the virtual coding block is always projected to the type A 4-parameter affine model.

In Step 4, based on the projected CPMVs after Step 3, in one example, the same candidate generation process used in the current VVC or AVS standards may be used. In another embodiment, the temporal motion vectors used in the candidate generation process for the current VVC or AVS standards may be not used for the non-adjacent neighboring blocks based derivation method. When the temporal motion vectors are not used, it indicates that the generated combinations do not contain any temporal motion vectors.

In Step 5, any newly generated candidate after Step 4 may go through a similarity check against all existing candidates that are already in the merge candidate list. The details of similarity check are already described in the section of Affine merge candidate pruning. If the newly generated candidate is found to be similar with any existing candidate in the candidate list, this newly generated candidate is removed or pruned.

FIG. 17 shows a computing environment (or a computing device) 1710 coupled with a user interface 1760. The computing environment 1710 can be part of a data processing server. In some embodiments, the computing device 1710 can perform any of various methods or processes (such as encoding/decoding methods or processes) as described hereinbefore in accordance with various examples of the present disclosure. The computing environment 1710 may include a processor 1720, a memory 1740, and an I/O interface 1750.

The processor 1720 typically controls overall operations of the computing environment 1710, such as the operations associated with the display, data acquisition, data communications, and image processing. The processor 1720 may include one or more processors to execute instructions to perform all or some of the steps in the above-described methods. Moreover, the processor 1720 may include one or more modules that facilitate the interaction between the processor 1720 and other components. The processor may be a Central Processing Unit (CPU), a microprocessor, a single chip machine, a GPU, or the like.

The memory 1740 is configured to store various types of data to support the operation of the computing environment 1710. Memory 1740 may include predetermine software 1742. Examples of such data include instructions for any applications or methods operated on the computing environment 1710, video datasets, image data, etc. The memory 1740 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The I/O interface 1750 provides an interface between the processor 1720 and peripheral interface modules, such as a keyboard, a click wheel, buttons, and the like. The buttons may include but are not limited to, a home button, a start scan button, and a stop scan button. The I/O interface 1750 can be coupled with an encoder and decoder.

In some embodiments, there is also provided a non-transitory computer-readable storage medium including a plurality of programs, such as included in the memory 1740, executable by the processor 1720 in the computing environment 1710, for performing the above-described methods. For example, the non-transitory computer-readable storage medium may be a ROM, a RAM, a CD-ROM, a magnetic tape, a floppy disc, an optical data storage device or the like.

The non-transitory computer-readable storage medium has stored therein a plurality of programs for execution by a computing device having one or more processors, where the plurality of programs when executed by the one or more processors, cause the computing device to perform the above-described method for motion prediction.

In some embodiments, the computing environment 1710 may be implemented with one or more application-specific integrated circuits (ASICs), digital signal processors (DSPs), digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

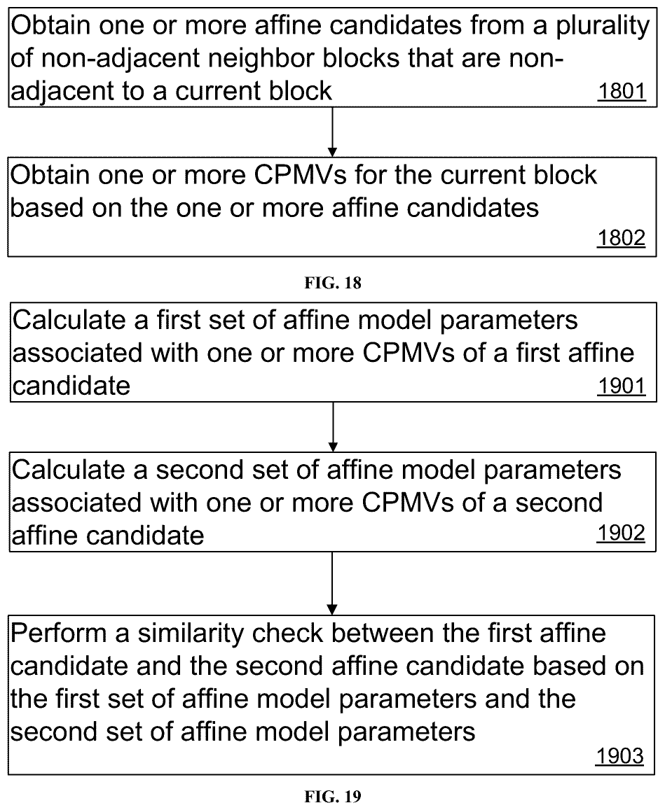

FIG. 18 is a flowchart illustrating a method for video coding according to an example of the present disclosure.

In step 1801, the processor 1720 may obtain one or more affine candidates from a plurality of non-adjacent neighbor blocks that are non-adjacent to a current block or CU.

In some examples, the plurality of non-adjacent neighbor blocks may include the non-adjacent coding blocks as shown in FIGS. 11-12, 13A-13B, 14A-14B, 15A-15D, and 16.

In some examples, the processor 1720 may obtain the one or more affine candidates according to a scanning rule.

In some examples, the scanning rule may be determined based on at least one scanning area, at least one scanning distance, and a scanning order.

In some examples, the at least one scanning distance indicates a number of blocks away from a side of the current block.

In some examples, one of the plurality of non-adjacent neighbor blocks at one of the at least one scanning distance may have the same size as the current block as shown in FIG. 13A or a different size from the current block as shown in FIG. 13B.

In some examples, the at least one scanning area may include a first scanning area and a second scanning area, the first scanning area is determined according to a first maximum scanning distance indicating a maximum number of blocks away from a first side of the current block, the second scanning area is determined according to a second maximum scanning distance indicating a maximum number of blocks away from a second side of the current block, and the first maximum scanning distance is the same as or different than the second maximum scanning distance. In some examples, the first maximum scanning distance or the second maximum scanning distance may be set as a fixed value, such as 3, 4, etc.

For example, the first scanning area may be the left side area of the current block 1303 and the first maximum scanning distance is 3 blocks away from the left side of the current block 1303. That is the block 1301 is at the first maximum scanning distance, i.e., 3 blocks away from the left side of the current block 1303. Furthermore, the second scanning area may be the upper side area of the current block 1303 and the second maximum scanning distance is 3 blocks away from the above or upper side of the current block 1303. That is the block 1302 is at the second maximum scanning distance, i.e., 3 blocks away from the upper/above side of the current block 1303.

In some examples, an encoder may signal the first maximum scanning distance and the second maximum scanning distance in a bitstream that is to be sent to a decoder.

In some examples, the processor 1720 may stop scanning in the at least one scanning area in response to determining that the first or second maximum scanning distance equals to the fixed value and in response to determining that a candidate list is full or that all non-adjacent neighbor blocks within the first or second maximum scanning distance have been scanned, as a scanning termination.

In some examples, the processor 1720 may scan a plurality of non-adjacent neighbor blocks in the first scanning area to obtain one or more non-adjacent neighbor blocks coded with affine mode and determine the one or more non-adjacent neighbor blocks coded with affine mode as the one or more affine candidates.

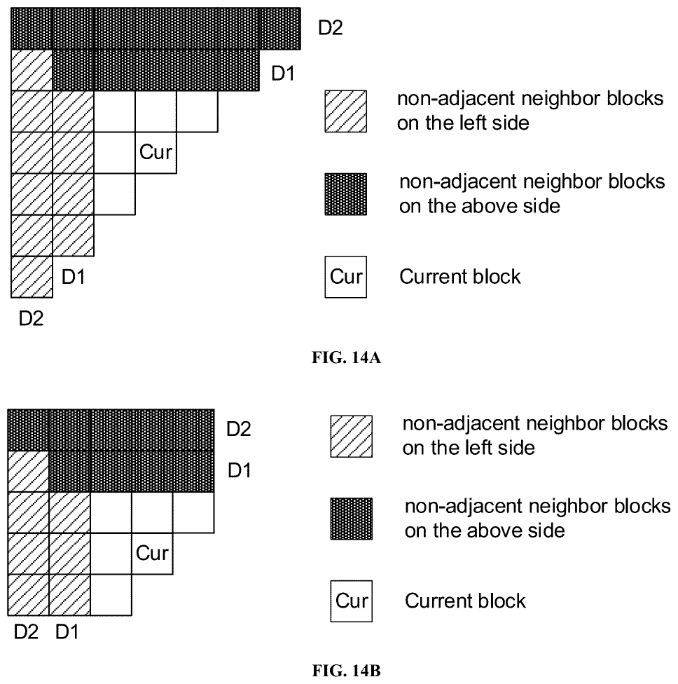

In some examples, the processor 1720 may scan from a first starting non-adjacent neighbor block along a scanning line parallel with a left side of the current block, where the first starting non-adjacent block is a bottom block in the first scanning area, blocks in the first scanning area are at the first scanning distance away, e.g., D2 in FIG. 14A, from the left side of the current block.

In some examples, the first starting non-adjacent block may be on the bottom and the left of a second starting non-adjacent neighbor block in a second scanning area, and blocks in the second scanning area may be at a second scanning distance, e.g., D1 in FIG. 14A, away from the left side of the current block, as shown in FIG. 14A. In some other examples, the first starting non-adjacent block may be on the left of a second starting non-adjacent neighbor block in a second scanning area, and blocks in the second scanning area may be at the second scanning distance away from the left side of the current block, as shown in FIG. 14B.

In some examples, the processor 1720 may scan from a third starting non-adjacent neighbor block along a scanning line parallel with an upper side of the current block, where the third starting non-adjacent block may be a right block in a first scanning area, and blocks in the first scanning area may be at a first scanning distance, e.g., D2 in FIG. 14A, away from the upper side of the current block.

In some examples, the third starting non-adjacent block may be on the top and the right of a fourth starting non-adjacent neighbor block in a second scanning area, and blocks in the second scanning area may be at a second scanning distance, e.g., D1 in FIG. 14A, away from the upper side of the current block, as shown in FIG. 14A. In some other examples, the third starting non-adjacent block may be on the right of a fourth starting non-adjacent neighbor block in a second scanning area, and blocks in the second scanning area may be at a second scanning distance away from the upper side of the current block, as shown in FIG. 14B.

In some examples, the processor 1720 may locate a non-adjacent neighbor block at a scanning position. For example, for easier implementation, each candidate non-adjacent neighboring block may be indicated or located by a specific scanning position.

In some examples, the scanning position may include a bottom-left position of the non-adjacent neighbor block in the second scanning area that is above the current block as shown in FIG. 15A, a top-right position of the non-adjacent neighbor block in the first scanning area that is on the left of the current block as shown in FIG. 15A, a bottom-right position of the non-adjacent neighbor block in the first scanning area or in the second scanning area as shown in FIG. 15B, a bottom-left position of the non-adjacent neighbor block in the first scanning area or in the second scanning area as shown in FIG. 15C, and a top-right position of the non-adjacent neighbor block in the first scanning area or in the second scanning area as shown in FIG. 15D.

In some examples, the processor 1720 may obtain a first candidate position for a first affine candidate and a second candidate position for a second affine candidate based on a scanning rule; determine a third candidate position based on the first and second candidate position for a third affine candidate; obtain a virtual block based on the first candidate position, the second candidate position, and the third candidate position; obtain three CPMVs for the virtual block based on translational MVs at the first candidate position, the second candidate position, and the third candidate position; and obtain two or three CPMVs for the current block based on the three CPMVs of the virtual block by using a same projection process used for inherited candidate derivation.

In some examples, the virtual block may be a rectangular coding block and the third candidate position may be determined based on a vertical position of the first candidate position and a horizontal position of the second candidate position. For example, the virtual block may be the virtual block including positions A, B and C as shown in FIG. 9.

In some examples, the processor 1720 may determine a vertical position of the third candidate position as a vertical position of a top-left point of the current block and determining a horizontal position of the third candidate position as a horizontal position of the top-left point of the current block in response to determining that the first candidate position or the second candidate position is unavailable or in response to determining that motion information at the first candidate position or the second candidate position is unavailable.

In some examples, the processor 1720 may determine that the virtual block is not capable of representing a valid affine model in response to determining that motion information at the first, second, or third candidate position is unavailable.

In some examples, the processor 1720 may determine that the virtual block is capable of representing a valid affine model in response to determining that at least one motion information at the first or second candidate position is available.

In some examples, the one or more affine candidates may include one or more affine inherited candidates and one or more affine constructed candidates and the processor 1720 may further obtain the one or more affine inherited candidates according to a first scanning rule and obtain the one or more affine constructed candidates according to a second scanning rule, where the second scanning rule is completely or partially same as the first scanning rule.

In some examples, the processor 1720 may further determine the second scanning rule based on at least one second scanning area, at least one second scanning distance, and a second scanning order and scan the at least one second scanning area at each distance equaling to a block size same as the current block.

In some examples, the processor 1720 may obtain two or three CPMVs for the current block based on the three CPMVs of the virtual block by using a same projection process used for inherited candidate derivation that includes that the processor 1720 may obtain the two or three CPMVs for the current block based on the three CPMVs of the virtual block by projecting the affine model of the first type represented by the virtual block to an affine model of the first type for the current block in response to determining that the virtual block represents an affine model of a first type; the processor 1720 may obtain the two or three CPMVs for the current block based on the three CPMVs of the virtual block by projecting the affine model of the second type represented by the virtual block to an affine model of the second type for the current block in response to determining that the virtual block represents an affine model of a second type; or the processor 1720 may obtain the two or three CPMVs for the current block based on the three CPMVs of the virtual block by projecting an affine model represented by the virtual block to an affine model of a type for the current block, where the type of the current block is the first type or the second type.

In step 1802, the processor 1720 may obtain one or more CPMVs for the current block based on the one or more affine candidates.

FIG. 19 is a flowchart illustrating a method for pruning an affine candidate according to an example of the present disclosure.

In step 1901, the processor 1720 may calculate a first set of affine model parameters associated with one or more CPMVs of a first affine candidate.

In step 1902, the processor 1720 may calculate a second set of affine model parameters associated with one or more CPMVs of a second affine candidate.

In step 1903, the processor 1720 may perform a similarity check between the first affine candidate and the second affine candidate based on the first set of affine model parameters and the second set of affine model parameters.

In some examples, the processor 1720 may determine that the first affine candidate is similar to the second affine candidate and pruning one of the first affine candidate and second affine candidate in response to determining that the first set of affine model parameters are similar to the second set of affine model parameters.

In some examples, the processor 1720 may determine that the first affine candidate is similar to the second affine candidate, where the plurality of differences include a difference between one parameter of the first set of affine model parameters and one corresponding parameter of the second set of affine model parameters in response to determining that a plurality of differences are respectively smaller than a plurality of threshold values.

In some examples, the plurality of threshold values may be determined according to the first set of affine model parameters that are comparable with the second set of affine model parameters, as shown in Table 1.

In some examples, the plurality of threshold values may be determined according to a size of a current block. For example, the plurality of threshold values are determined according to a width or a height of a current block, as shown in Table 2, 3, or 4. For another example, the plurality of threshold values may be determined as a group of fixed values, as shown in Table 5.

In some example, the processor 1720 may calculate one or more affine model parameters of the first set of affine model parameters associated with the one or more CPMVs of the first affine candidate according to a width and a height of a current block and calculate one or more affine model parameters of the second set of affine model parameters associated with the one or more CPMVs of the second affine candidate according to the width and the height of the current block.

In some examples, there is provided an apparatus for video coding. The apparatus includes a processor 1720 and a memory 1740 configured to store instructions executable by the processor; where the processor, upon execution of the instructions, is configured to perform a method as illustrated in FIG. 18.

In some other examples, there is provided a non-transitory computer readable storage medium, having instructions stored therein. When the instructions are executed by a processor 1720, the instructions cause the processor to perform a method as illustrated in FIG. 18.

In some examples, there is provided an apparatus for video coding. The apparatus includes a processor 1720 and a memory 1740 configured to store instructions executable by the processor; where the processor, upon execution of the instructions, is configured to perform a method as illustrated in FIG. 19.

In some other examples, there is provided a non-transitory computer readable storage medium, having instructions stored therein. When the instructions are executed by a processor 1720, the instructions cause the processor to perform a method as illustrated in FIG. 19.

This application is intended to cover any variations, uses, or adaptations of the disclosure following the general principles thereof and including such departures from the present disclosure as come within known or customary practice in the art. It is intended that the specification and examples be considered as exemplary only.

It will be appreciated that the present disclosure is not limited to the exact examples described above and illustrated in the accompanying drawings, and that various modifications and changes can be made without departing from the scope thereof.

What is claimed is:

1. A method of video coding, comprising:
obtaining one or more affine candidates from a plurality of non-adjacent neighbor blocks that are non-adjacent to a current block; and
obtaining one or more control point motion vectors (CPMVs) for the current block based on the one or more affine candidates.

2. The method of claim 1, wherein obtaining one or more affine candidates comprises:
obtaining the one or more affine candidates according to a scanning rule.

3. The method of claim 2, further comprising:
determining the scanning rule based on at least one scanning area, at least one scanning distance, and a scanning order.

4. The method of claim 3, further comprising:
determining the at least one scanning area according to the at least one scanning distance.

5. The method of claim 4, wherein the at least one scanning area comprises a first scanning area and a second scanning area, the first scanning area is determined according to a first maximum scanning distance indicating a maximum number of blocks away from a first side of the current block, the second scanning area is determined according to a second maximum scanning distance indicating a maximum number of blocks away from a second side of the current block, and the first maximum scanning distance is the same as or different than the second maximum scanning distance.

6. The method of claim 5, further comprising:
receiving, from a bitstream, the first maximum scanning distance and the second maximum scanning distance.

7. The method of claim 5, further comprising:
predetermining the first maximum scanning distance or the second maximum scanning distance as a fixed value.

8. The method of claim 7, further comprising:
in response to determining that the first maximum scanning distance or the second maximum scanning distance equals to 4, and in response to determining that a candidate list including the one or more affine candidates is full or determining that all non-adjacent neighbor blocks within the first maximum scanning distance and the second maximum scanning distance are scanned, stop scanning in the at least one scanning area.

9. The method of claim 3, further comprising:
scanning from a first starting non-adjacent neighbor block along a scanning line parallel with a left side of the current block, wherein the first starting non-adjacent block is a bottom block in a first scanning area, and blocks in the first scanning area are at a first scanning distance away from the left side of the current block.

10. The method of claim 3, further comprising:
scanning from a third starting non-adjacent neighbor block along a scanning line parallel with an upper side of the current block, wherein the third starting non-adjacent block is a right block in a first scanning area, blocks in the first scanning area are at a first scanning distance away from the upper side of the current block.

11. The method of claim 3, further comprising:
locating a non-adjacent neighbor block at a scanning position.

12. The method of claim 1, further comprising:
obtaining a first candidate position for a first affine candidate and a second candidate position for a second affine candidate based on a scanning rule;
determining a third candidate position based on the first and second candidate positions for a third affine candidate;
obtaining a virtual block based on the first candidate position, the second candidate position, and the third candidate position;
obtaining three CPMVs for the virtual block based on translational MVs at the first candidate position, the second candidate position, and the third candidate position; and
obtaining two or three CPMVs for the current block based on the three CPMVs of the virtual block by using a same projection process used for inherited candidate derivation.

13. The method of claim 12, wherein the virtual block is a rectangular coding block and the third candidate position is determined based on a vertical position of the first candidate position and a horizontal position of the second candidate position.

14. The method of claim 12, further comprising:
in response to determining that the first candidate position or the second candidate position is unavailable or in response to determining that motion information at the first candidate position or the second candidate position is unavailable, determining a vertical position of the third candidate position as a vertical position of a top-left point of the current block and determining a horizontal position of the third candidate position as a horizontal position of the top-left point of the current block.

15. The method of claim 12, further comprising:
in response to determining that motion information at the first, second, or third candidate position is unavailable, determining that the virtual block is not capable of representing a valid affine model, or
in response to determining that at least one motion information at the first or second candidate position is available, determining that the virtual block is capable of representing a valid affine model.

16. The method of claim 1, wherein the one or more affine candidates comprises one or more affine inherited candidates and one or more affine constructed candidates,
and the method further comprises:
obtaining the one or more affine inherited candidates according to a first scanning rule; and
obtaining the one or more affine constructed candidates according to a second scanning rule, wherein the second scanning rule is completely or partially same as the first scanning rule.

17. The method of claim 16, further comprising:
determining the second scanning rule based on at least one second scanning area, at least one second scanning distance, and a second scanning order; and
scanning the at least one second scanning area at each distance equaling to a block size same as the current block.

18. The method of claim 12, wherein obtaining the two or three CPMVs for the current block based on the three CPMVs of the virtual block by using the same projection process used for inherited candidate derivation comprises at least one of followings:
in response to determining that the virtual block represents an affine model of a first type, obtaining the two or three CPMVs for the current block based on the three CPMVs of the virtual block by projecting the affine model of the first type represented by the virtual block to an affine model of the first type for the current block;
in response to determining that the virtual block represents an affine model of a second type, obtaining the two or three CPMVs for the current block based on the three CPMVs of the virtual block by projecting the affine model of the second type represented by the virtual block to an affine model of the second type for the current block; or
obtaining the two or three CPMVs for the current block based on the three CPMVs of the virtual block by projecting an affine model represented by the virtual block to an affine model of a type for the current block, wherein the type of the current block is a first type or a second type.

19. An apparatus for video coding, comprising:
one or more processors; and
a memory coupled to the one or more processors and configured to store instructions executable by the one or more processors and a bitstream to be decoded,
wherein the one or more processors, upon execution of the instructions, are configured to perform operations with the bitstream, wherein the operations comprising:
obtaining one or more affine candidates from a plurality of non-adjacent neighbor blocks that are non-adjacent to a current block; and
obtaining one or more control point motion vectors (CPMVs) for the current block based on the one or more affine candidates.

20. A non-transitory computer-readable storage medium storing computer-executable instructions and a bitstream to be decoded, when the computer-executable instructions executed by one or more computer processors, cause the one or more computer processors to perform operations with the bitstream, wherein the operations comprising:
obtaining one or more affine candidates from a plurality of non-adjacent neighbor blocks that are non-adjacent to a current block; and
obtaining one or more control point motion vectors (CPMVs) for the current block based on the one or more affine candidates.
